(19) United States
(12) Patent Application Publication
(10) Pub. No.: US 2008/0178903 A1
(43) Pub. Date: Jul. 31, 2008

(54) Rotating Sifter

(76) Inventors: Timothy Thorpe, Santa Monica, CA (US); Luis Alviar, Santa Monica, CA (US)

Correspondence Address: LEE & HAYES, PLLC, 421 W. RIVERSIDE AVE, STE 500, SPOKANE, WA, 99201, US

(21) Appl. No.: 11/977,385

(22) Filed: Jan. 25, 2007

(51) Int. Cl. A45D 33/02; B67D 5/06; A47G 19/24

(52) U.S. Cl. 132/307; 222/182; 222/565; 222/562

(57) ABSTRACT

Containers are disclosed for holding and dispensing cosmetic products. Exemplary containers have a bottom portion, a first and second sifter, and a removable cover having a protrusion. The first sifter may have at least one sifting hole for sifting materials with a powder-like consistency. The second sifter may be rotatably engaged with the first sifter and may also have at least one sifting hole. The second sifter may rotate with the rotation of the cover, such that when the cover is rotated into a closed position the second sifter is rotated in relation to the first sifter to offset the holes in the first sifter and the holes in the second sifter. When the cover is rotated into an open position the second sifter is rotated in relation to the first sifter to align the holes in the first sifter with the holes in the second sifter.

### BACKGROUND

Cosmetic materials such as those used for cosmetic foundation are typically provided as a compacted or a loose powder. Loose materials, including loose powder, are becoming more common due in part to the fact that loose material provides improved coverage of the material on a surface. The loose material may be provided in a container with a perforated surface or sifter so that the powder is shaken out of the perforations and the powder can be applied onto an applicator This configuration is problematic in that the loose material has a tendency to move up through the perforations during handling and/or jostling of the container, such as the movements associated with carrying the container in a handbag, pocket, or purse. The loose material may deposit above the perforated surface and/or on the cap and may at least partially spill out when the container is opened.

### SUMMARY

This disclosure relates to containers usable for holding and dispensing, among other things, powdered or powder-like cosmetics products. Containers are disclosed that have a bottom portion, a first sifter, a second sifter and a removable cover having a protrusion. The first sifter may be engaged with the bottom portion and may have at least one sifting hole for sifting materials with a powder-like consistency. A generally L-shaped opening may extend along a circumferential surface of the first sifter for receiving the protrusion. A second sifter may be rotatably engaged with the first sifter and may have at least one sifting hole. The second sifter may have an opening for aligning with a portion of the generally L-shaped opening and accepting the protrusion. When the cover is rotated, the protrusion extending into the openings in the first and second sifters may travel along the generally L-shaped opening to secure the cover to the first sifter. The second sifter may rotate with the rotation of the cover, such that when the cover is rotated into a closed position the second sifter is rotated in relation to the first sifter to offset the holes in the first sifter and the holes in the second sifter. When the cover is rotated into an open position the second sifter is rotated in relation to the first sifter to align the holes in the first sifter with the holes in the second sifter.

A process of filling containers having a rotating sifter from the bottom of the container is also disclosed. The method may include providing a container with a top portion, an open bottom portion, a rotating sifter mechanism engaged with the top portion, a cover for enclosing the top portion, and a bottom cap for enclosing the open bottom portion. The rotating sifter mechanism may be engaged with the top portion. The cover may be engaged with the rotating sifter mechanism. The container may then be positioned so that the open bottom portion faces toward a filling mechanism. Material may be supplied from the filling mechanism to the open bottom portion. The bottom cap may then be affixed to the open bottom portion to enclose the material within the container.

### BRIEF DESCRIPTION OF THE DRAWINGS

FIG. 1 shows an exploded view of a container having a rotating sifter, according to one exemplary implementation.

FIG. 2 shows an elevational view of the container of FIG. 1.

FIG. 3 shows a top plan view of the container of FIG. 1.

FIG. 4A shows a cross-sectional view of the container of FIG. 1, taken along line 4-4 in FIG. 3.

FIG. 4B shows a cross-sectional view of the container of FIG. 1, taken along line 4-4 in FIG. 3 and in which an elastomer layer is sandwiched between the first and second sifters.

FIG. 5 shows a perspective view of the underside of the cover for the rotating sifter of FIG. 1.

FIG. 6 is an exploded view of a container according to another exemplary implementation, having a rotating sifter mechanism including a first sifter and a second sifter, the first sifter having openings along its circumference that correspond to openings in a bottom portion of the container.

FIG. 7 shows a cross-sectional view of the container of FIG. 6.

FIG. 8 is an exploded view of a container according to another exemplary implementation, having a rotating sifter mechanism including a first sifter and a second sifter, the first sifter being integral with a bottom portion of the container, and a bottom cap for enclosing the bottom portion of the container

FIG. 9 shows a cross-sectional view of the container of FIG. 8.

### DETAILED DESCRIPTION

Containers having rotating sifter mechanisms will now be described with reference to the figures. While the disclosure is described in the context of sifters for powdered cosmetics products, they may be useful for other powdered or powder-like products, such as baby powder, foot powder, medicinal powders, and the like.

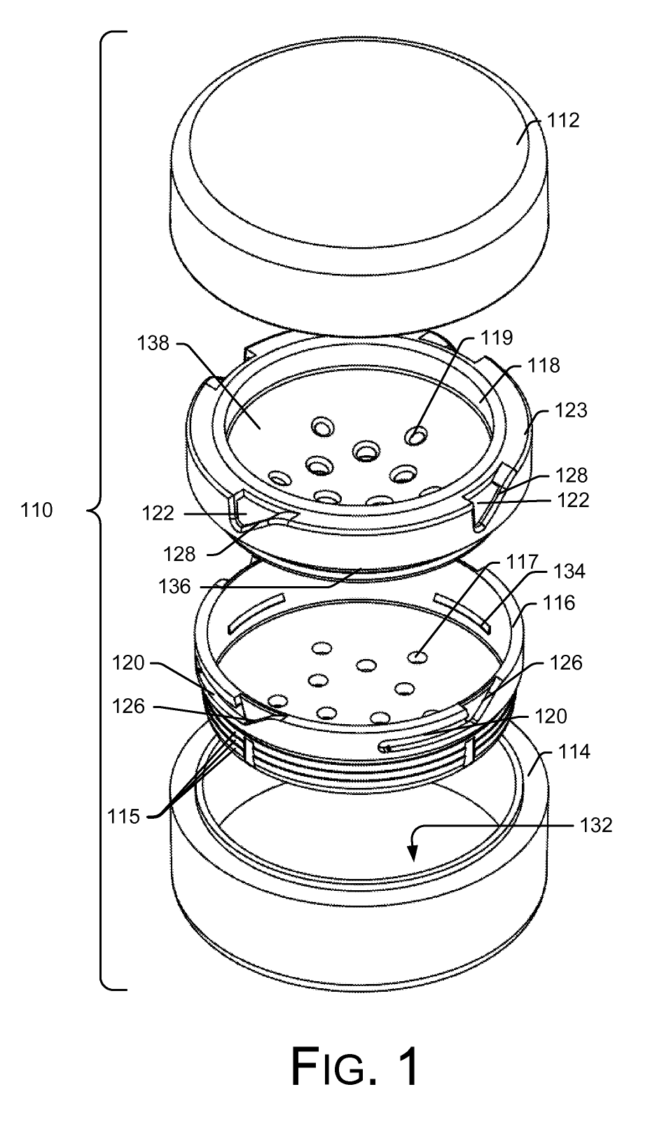

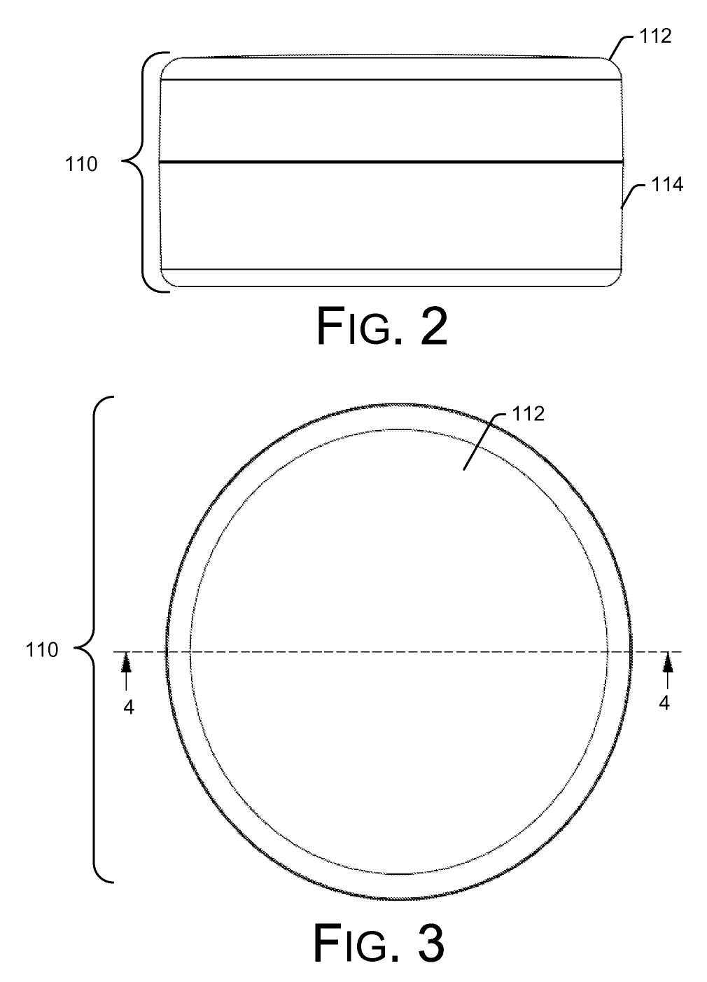

FIGS. 1-5 show a container 110 comprising a cover 112 and a bottom portion 114. As shown in FIG. 1, the container may be provided with a first sifter 116 engaged with the bottom portion 114. A second sifter 118 may be engaged with the first sifter 116. The first sifter 116 may have one or more holes 117 for sifting loose material, such as facial powder, makeup, or the like stored within a cavity 132 in the bottom portion 114. The second sifter 118 may have one or more holes 119, which may be capable of aligning with the holes 117 in the first sifter 116. Thus, a user may access the powder by at least slightly inverting the container 110 to sift the loose material through the holes 117 and 119.

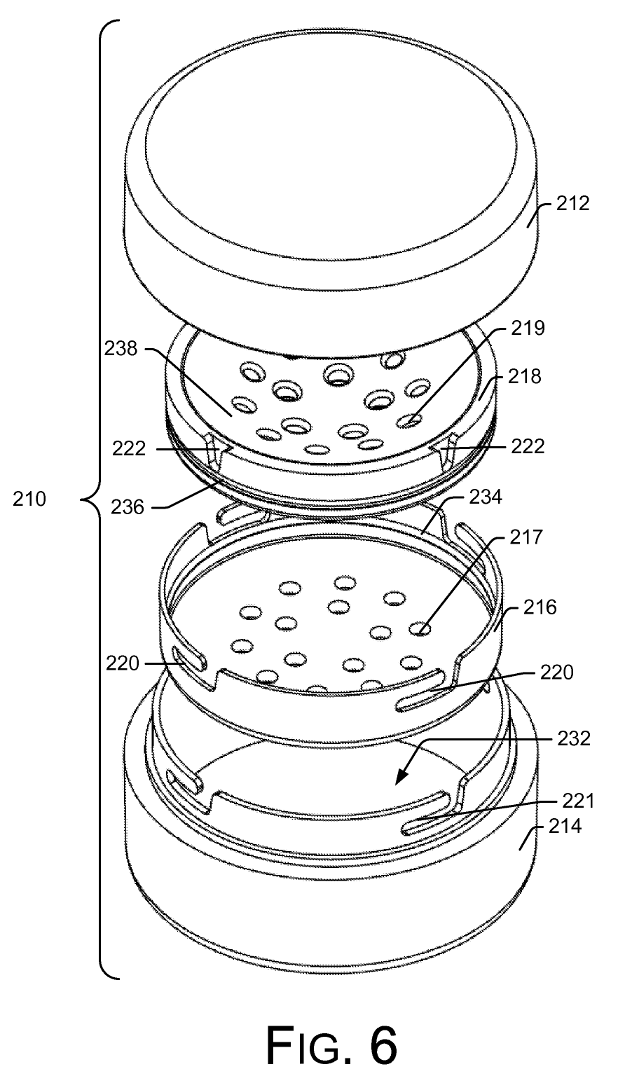

The container 110 may be provided with a mechanism to rotate the second sifter 118 in relation to the first sifter 116 so that the sifters 116 and 118 are aligned when the container 110 is “open” to allow a user to access the powder. When the container 110 is “closed,” the sifters 116 and 118 are moved out of alignment, which prevents powder from traveling from the bottom portion 114 through the sifters 116 and 118. In order to rotate the sifter 116 while opening or closing the container 110, the first sifter 116 may have one or more generally L-shaped openings 120 extending along its circumference. The second sifter 18 may have one or more openings 122 for aligning with a portion of the generally L-shaped opening extending along the circumference of the first sifter 116. The cover 112 may have one or more protrusions 124, shown in FIG. 5 that extend into the openings 120 and 122 in the first and second sifters 116 and 118. The one or more protrusions 124 may travel in the generally L-shaped openings 120 during a rotation of the cover to close the container. The protrusions 124 may engage with openings 122 thus rotating the second sifter 118 with the rotation of the cover 112.

The generally L-shaped openings 120 may have a downwardly sloped portion 126 along the circumference of the first sifter. The cover 112 moves toward or away from the bottom portion 114 of the container 110 as the protrusion 124 is moved along the generally sloped portion 126 of the L-shaped opening 120. For example, according to the configuration shown in FIG. 1, as the cover 112 is rotated in a clockwise motion, the protrusions 124 may travel down the sloped portion 126, by virtue of the force applied by the user and by gravity, to guide the cap downward relative to the bottom portion 114 and position the cover 112 for tightly closing and sealing the container 110. As the cover 112 is rotated in a counter-clockwise motion, the cover 112 is separated from the bottom portion 114 by virtue of the protrusions 124 traveling upward along the sloped portion 126. Openings 122 in the second sifter 118 may also be provided with downwardly sloping portions 128 to correspond to or align with the sloped portion 126 of the opening 120.

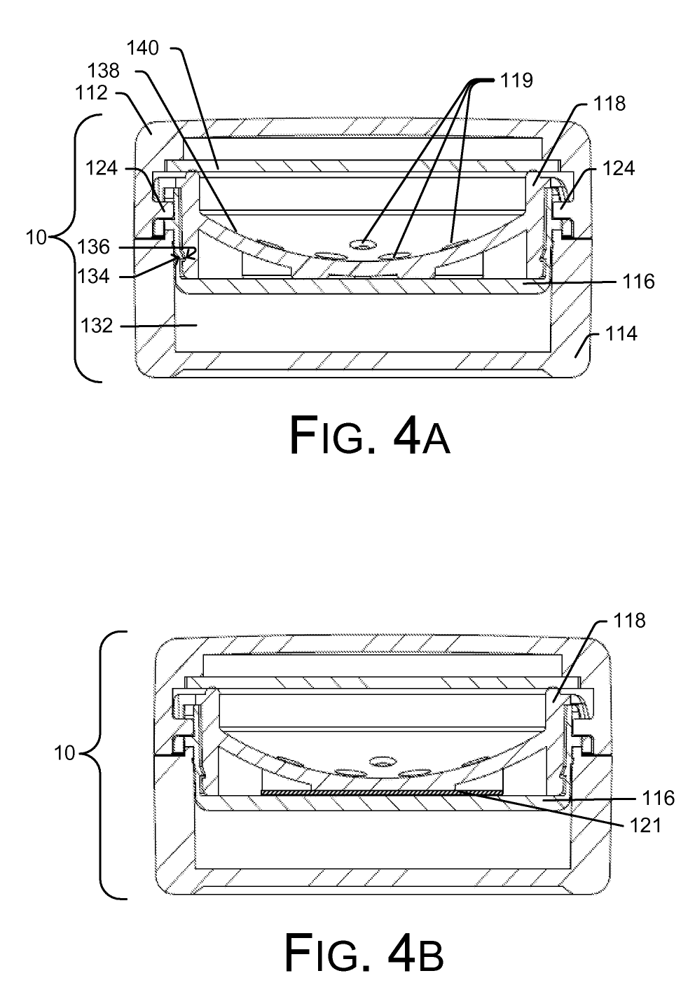

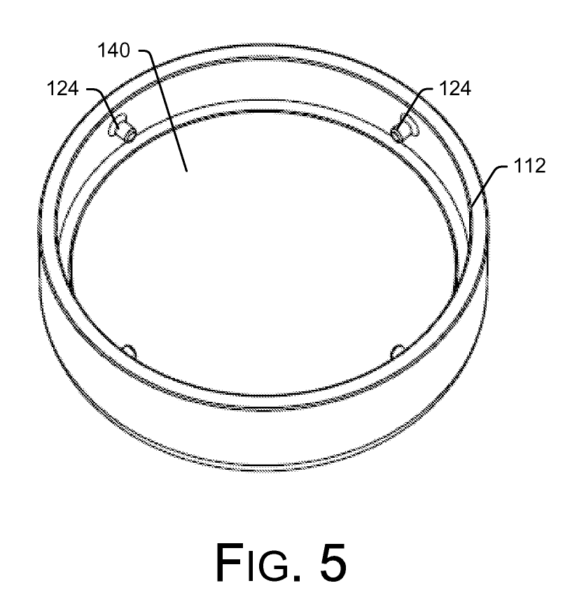

The first sifter 116 may be secured or fixed to the bottom portion 114 by friction, glue, threaded engagement, or other suitable means. As shown in FIG. 1, ribs 115 or other contoured features may additionally provide a surface for maintaining the first sifter 16 in the bottom portion 114. The first sifter 116 may be positioned to create a loose material holding area 132 as illustrated in FIG. 4.

The second sifter 118 may be secured to the first sifter 116 by friction or other suitable means. Additionally or alternatively, one or more ribs 134 on the first sifter 116 may be configured to engage with one or more grooves 136 in the second sifter 118. Groove 136 may be a circular groove along the outer circumference of second sifter 118. The second sifter 118 may also have a rim portion 123 that extends around a portion of the first sifter 116. Openings 122 may be positioned along the rim portion 123. The protrusions 124 may be configured to be inwardly projecting from cover 112 to pass through openings 122 and extend to openings 120, thus securing cover 112 directly to the first and second sifters 116 and 118.

The second sifter 118 may have a concave or sloped surface 138 on the side of the second sifter 118 facing away from the first sifter 116, i.e., the surface facing upward from the bottom portion 114. This surface 138 may assist in directing powder or other material into the one or more holes 119 and, thus, into loose material holding area 132. This concave or sloped surface 138 may reduce the amount of powder or other material above the second sifter 118 when the container 110 is held in an upright position, such as when a user is preparing to close the container 110. Reducing the amount of powder above the second sifter 118 and maintaining the holes 117 and 119 in an offset configuration while the cover is closed may reduce the amount of powder that may be spilled while the container 110 is closed or when the container 110 is initially opened. The cover 112 may have a sealing layer 140 engaged with the cover 112 for pressing or touching the second sifter 118 to further prevent the unintentional spillage of powder from container 110.

As shown in FIG. 4B, the second sifter 118 may be provided with an elastomeric layer 121, which may be a co-molded thermoplastic elastomer (TPE). The elastomeric layer 121 may be formed on the side of the second sifter 118 facing the first sifter 116 and may deform and seal any gap between the first sifter 116 and the second sifter 118, particularly in the vicinity of the holes 117 and 119. The elastomeric layer 121 may alternatively be provided on the first sifter 118 on the side facing the second sifter 118.

Bottom portion 114, first sifter 116, second sifter 118, and cover 112 may be constructed of polypropylene or other suitable material and may be molded or formed according to other conventional methods. The sealing layer 140 may be waxed paperboard, Teflon, or other suitable material.

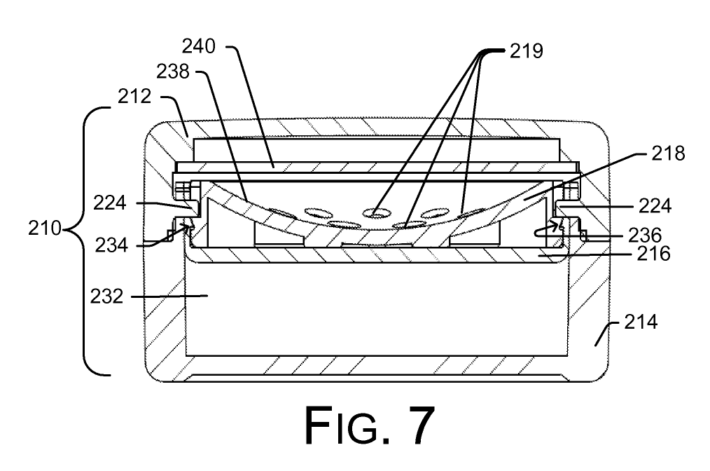

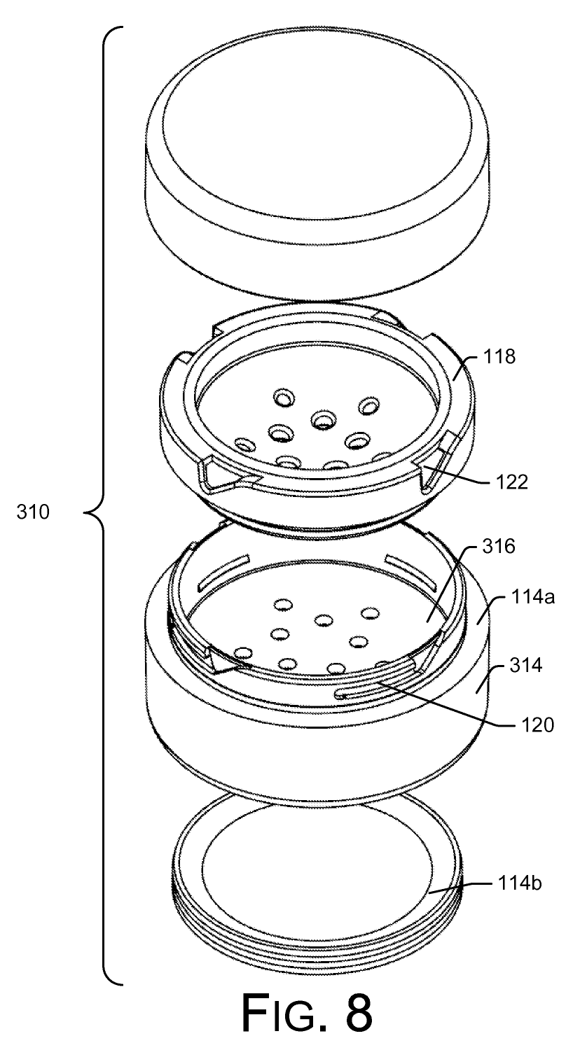

FIGS. 6 and 7 show an alternative implementation to the rotating sifter shown in FIGS. 1-5. More particularly, FIGS. 6 and 7 show a container 210 comprising a cover 212 and a bottom portion 214. Similar to the configuration shown in FIG. 1, the container 210 may be provided with a first sifter 216 engaged with the bottom portion 214 and a second sifter 218 engaged with the first sifter 216. The second sifter 218 may rotate with the rotation of the cover 212 due to the engagement with protrusions 224. However, in the embodiment shown in FIGS. 6 and 7, the bottom portion 214 may be provided with one or more generally L-shaped openings 221 that are aligned with the L-shaped openings 220 in the first sifter 216. Thus, the one or more protrusions 224 may travel in the generally L-shaped openings 220 and 221 and the openings 222 during a rotation of the cover 212, to secure the cover 212 to the first sifter 216, the second sifter 218, and the bottom portion 214.

The first sifter 216 may be press fit, friction fit, threadedly engaged, or otherwise secured the bottom portion 214 with openings 220 aligned with openings 221. The second sifter 218 may be secured to the first sifter 216 by one or more ribs 234 on the first sifter 216 configured to engage with one or more grooves 236 in the second sifter 218. Groove 236 may be a circular groove along the outer circumference of second sifter 218. Rib 236 may be a circular rib along the inner circumference of first sifter 216.

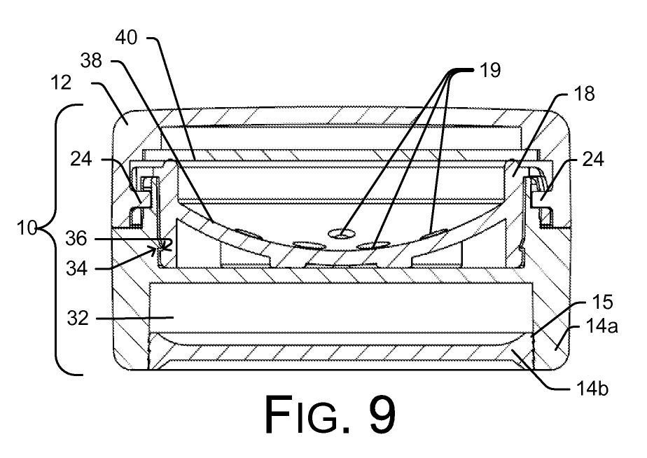

FIGS. 8 and 9 show a variation of the container shown in FIGS. 1-5, in which the first sifter and bottom portion are integral and the bottom portion has a bottom cap. More particularly, container 310 has a bottom portion 14a with a container wall portion 314 and an integral sifter 316. Bottom cap 14b allows a user to load powder into the bottom portion 14a of the container after assembling the container 310 by a process of inverting the container, filling the bottom portion 14a with powder, and affixing bottom cap 14b. The bottom cap 14b may be engaged with the bottom portion 14a by friction, glue, threaded engagement, and/or other suitable engagement means. Ribs 15 may assist in maintaining the engagement of bottom cap 14b with bottom portion 14a. These variations of the bottom cap and the integral bottom portion and sifter may also be implemented in the embodiments shown in FIGS. 6 and 7.

Container 310 may be filled with powder according to a bottom filling process. Container 310 may be assembled by engaging the second sifter 18 with the bottom portion 14a. The cover may be engaged with the openings 20 and 22 such that the cover 12 is in the closed position. The user may then position the container so that the open bottom portion faces toward a filling mechanism. The filling mechanism may supply material, such as facial powder, to the open bottom portion. The bottom cap 14b may then be secured to the bottom portion 14a to complete the filling process and enclose the material within the container.

It is noted that the first sifter need not be integral with bottom portion for the bottom filling process. Instead the bottom sifter may be configured as a distinct component, such as the first sifter 116 shown in FIG. 1.

Although details of specific implementations and embodiments are described above, such details are intended to satisfy statutory disclosure obligations rather than to limit the scope of the following claims. Thus, the claims are not limited to the specific features described above.

What is claimed is:

1. A container comprising:
a bottom portion;
a first sifter engaged with the bottom portion and having at least one sifting hole and a generally L-shaped opening extending along a circumferential surface of the first sifter;
a second sifter rotatably engaged with the first sifter and having at least one sifting hole and an opening for aligning with a portion of the generally L-shaped opening; and
a removable cover having a protrusion to extend into the openings in the first and second sifters, the protrusion for traveling along the generally L-shaped opening during a rotation of the cover to secure the cover to the first sifter, the protrusion also for engaging with the second sifter so that.
when the cover is rotated into a closed position the second sifter is rotated in relation to the first sifter to offset the one or more holes in the first sifter and the one or more holes in the second sifter, and
when the cover is rotated into an open position the second sifter is rotated in relation to the first sifter to align the one or more holes in the first sifter with the one or more holes in the second sifter.

2. A container according to claim 1, wherein a portion of the generally L-shaped opening has a sloped portion extending downwardly along the circumferential surface of the first sifter to move the cover toward or away from the bottom of the container as the protrusion is moved along the sloped portion of the generally L-shaped opening.

3. A container according to claim 1, wherein the bottom portion of the container is provided with a generally L-shaped opening that corresponds to the generally L-shaped opening in the first sifter and the protrusion in the cover extends into the L-shaped openings in the bottom portion and the first sifter.

4. A container according to claim 1, wherein the first sifter has four generally L-shaped openings extending along a circumferential surface of the first sifter, he second sifter has four openings, each opening for aligning with a portion of one of the generally L-shaped openings in the first sifter, and the cover has four protrusions, each protrusion for traveling along one of the generally L-shaped openings during a rotation of the cover to close the container.

5. A container according to claim 1, wherein the second sifter is provided with an elastomeric material on at least a portion of the surface of the second sifter facing the first sifter, the elastomeric material for sealing a gap between the first sifter and the second sifter in the vicinity of the sifting holes in the first and second sifters.

6. A container according to claim 5, wherein the elastomeric material is a co-molded thermoplastic elastomer.

7. A container according to claim 1, wherein the first sifter and bottom portion are integral.

8. A container according to claim 7, further comprising a bottom cap engaged with the bottom portion.

9. A container according to claim 1, wherein the second sifter has a concave surface on the side of the second sifter opposite the first sifter, the concave surface for directing loose material to the sifting holes in the first and second sifters.

10. A container according to claim 1, wherein:
a portion of the generally L-shaped opening has a sloped portion extending downwardly along the circumferential surface of the first sifter to move the cover toward or away from the bottom of the container as the protrusion is moved along the sloped portion of the generally L-shaped opening,
the first sifter has four generally L-shaped openings extending along a circumferential surface of the first sifter, the second sifter has four openings, each opening for aligning with a portion of one of the generally L-shaped openings in the first sifter, and the cover has four protrusions, each protrusion for traveling along one of the generally L-shaped openings during a rotation of the cover to close the container,
a portion of each of the four generally L-shaped openings has a sloped portion extending downwardly along the circumferential surface of the first sifter to move the cover toward or away from the bottom of the container as the protrusion is moved along the sloped portion of the generally L-shaped opening,
the second sifter is provided with a co-molded thermoplastic elastomer material on at least a portion of the surface of the second sifter facing the first sifter, the co-molded thermoplastic elastomer material for sealing a gap between the first sifter and the second sifter in the vicinity of the sifting holes in the first and second sifters,
the first sifter and bottom portion are integral,
a bottom cap is engaged with the bottom portion, and
the second sifter has a concave surface on the side of the second sifter opposite the first sifter, the concave surface for directing loose material to the sifting holes in the first and second sifters.

11. An apparatus comprising:
a bottom portion for containing a loose material;
a first sifter having one or more holes for sifting the loose material, the first sifter engaged with the bottom portion;
a second sifter having one or more holes for sifting the loose material, the second sifter rotatably engaged with the first sifter; and
a removable cover having a protrusion for inserting in an opening in the first sifter and in an opening in the second sifter, wherein the opening in the second sifter is configured to engage the protrusion extending from the cover so that:
when the cover is rotated to a closed position the second sifter is rotated relative to the first sifter to offset the one or more holes in the first sifter relative the one or more holes in the second sifter, and
when the cover is rotated to an open position the second sifter is rotated relative to the first sifter to align the one or more holes in the first sifter with the one or more holes in the second sifter.

12. An apparatus according to claim 11, wherein the opening in the second sifter has a downwardly sloped portion and the opening in the first sifter has a downwardly sloped portion, wherein the downwardly sloped portions in the first and second sifters align to accept the protrusion extending from the cover.

13. An apparatus according to claim 12, wherein the downwardly sloped portion of the opening in the first sifter extends to a circumferentially extending opening in the first sifter.

14. An apparatus according to claim 11, wherein the second sifter is provided with an elastomeric material on at least a portion of the surface of the second sifter facing the first sifter, the elastomeric material for sealing a gap between the first sifter and the second sifter in the vicinity of the holes in the first and second sifters.

15. A container according to claim 14, wherein the elastomeric material is a co-molded thermoplastic elastomer.

16. An apparatus according to claim 11, wherein the bottom portion comprises a container wall portion and a bottom cap portion.

17. An apparatus according to claim 16, wherein the first sifter and the container wall portion are integral.

18. An apparatus according to claim 11, wherein
the opening in the second sifter has a downwardly sloped portion and the opening in the first sifter has a downwardly sloped portion, wherein the downwardly sloped portions in the first and second sifters align to accept the protrusion extending from the cover,
the downwardly sloped portion of the opening in the first sifter extends to a circumferentially extending opening in the first sifter,
the second sifter is provided with a a co-molded thermoplastic elastomer material on at least a portion of the surface of the second sifter facing the first sifter, the a co-molded thermoplastic elastomer material for sealing a gap between the first sifter and the second sifter in the vicinity of the holes in the first and second sifters,
the bottom portion comprises a container wall portion and a bottom cap portion, and
the first sifter and the container wall portion are integral.

19. A process for filling a container having a rotating sifter mechanism comprising:
providing a container with a top portion, an open bottom portion a rotating sifter mechanism engaged with the top portion, and a cover enclosing the top portion;
positioning the container with the open bottom portion so that the open bottom portion faces toward a filling mechanism;
supplying material from the filling mechanism to the open bottom portion; and
providing a bottom cap to the open bottom portion to enclose the material within the container.

20. A process according to claim 19, wherein providing a container with a rotating sifter mechanism comprises:
providing a first sifter with one or more holes engaged with the open top portion; and
providing a second sifter with one or more holes, the second sifter rotatably engaged with the first sifter.

21. A process according to claim 20, wherein the cover is provided with inwardly facing protrusions for engaging with an opening in the second sifter so that rotating the cover rotates the second sifter relative to the first sifter.

22. A process according to claim 21, wherein rotating the cover into a closed position rotates the second sifter relative to the first sifter to offset the one or more holes in the first sifter relative the one or more holes in the second sifter and wherein rotating the cover into an open position rotates the second sifter relative to the first sifter to align the one or more holes in the first sifter with the one or more holes in the second sifter.
